(19) United States
(12) Patent Application Publication
(10) Pub. No.: US 2025/0388823 A1
(43) Pub. Date: Dec. 25, 2025

(54) FCC PROCESS USEFUL FOR PRODUCTION OF PETROCHEMICALS

(71) Applicant: W.R. Grace & Co.-CONN., Columbia, MD (US)

(72) Inventors: Ruizhong Hu, Cooksville, MD (US); Guang Yuan, Clarksville, MD (US); Wu-Cheng Cheng, Ellicott City, MD (US); Udayshankar Singh, Columbia, MD (US); Ken Bryden, Columbia, MD (US); Scott Purnell, Columbia, MD (US)

(21) Appl. No.: 18/879,343

(22) PCT Filed: Jun. 28, 2023
(86) PCT No.: PCT/US2023/026482

§ 371 Date: Dec. 27, 2024

Related U.S. Application Data
(60) Provisional application No. 63/356,940, filed on Jun. 29, 2022.

(51) Int. Cl. C10G 11/05

(52) U.S. Cl. CPC C10G 11/05; C10G 2300/1074; C10G 2400/02; C10G 2400/20; C10G 2400/30

(57) ABSTRACT

A catalytic cracking process for producing light olefins and aromatic gasoline includes contacting a petroleum-based feedstock with a catalyst in a single riser reactor, where the catalyst includes 0 wt % to about 15 wt % of a Y-type zeolite and greater than 30 wt % of a pentasil zeolite, a weight ratio of pentasil zeolite to Y-type zeolite greater than 3; and a weight hourly space velocity (WHSV) is about 40 h⁻¹ to about 120 h⁻¹.

### CROSS REFERENCE TO RELATED APPLICATIONS

This application claims the benefit of priority to U.S. Provisional Patent Application No. 63/356,940 filed Jun. 29, 2022, which is hereby incorporated by reference, in its entirety for any and all purposes.

### TECHNICAL FIELD

The present technology generally relates to a catalytic cracking process for producing light olefins and aromatic gasoline.

### SUMMARY OF THE PRESENT TECHNOLOGY

In an aspect, the present technology provides a catalytic cracking process for producing light olefins and aromatic gasoline, where the process includes contacting a petroleum-based feedstock with a catalyst in a single riser reactor at a temperature and a weight hourly space velocity (WHSV) to convert at least a portion of the petroleum-based feedstock into light olefins and aromatic gasoline, where the temperature is from about 530° C. to about 600° C., the WHSV is from about 40 h⁻¹ to about 120 h⁻¹. The catalyst includes 0 wt % to about 15 wt % of a Y-type zeolite and greater than 30 wt % of a pentasil zeolite, where a weight ratio of the pentasil zeolite to the Y-type zeolite is greater than 3, and a weight ratio of catalyst to petroleum-based feedstock is from about 10:1 to about 30:1, optionally from about 13:1 to about 25:1, and the aromatic gasoline is obtained from C5+ to 221° C. cut point.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The phrase “and/or” as used in the present disclosure will be understood to mean any one of the recited members individually or a combination of any two or more thereof—for example, “A, B, and/or C” would mean “A, B, C, A and B, A and C, B and C, or the combination of A, B, and C.”

As utilized herein with respect to numerical ranges, the terms “about,” “approximately,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be understood to mean plus or minus 10% of the disclosed values—for example, “about 10 wt. %” would mean “9 wt. % to 11 wt. %”. It is to be understood that when “about,” “approximately,” and “substantially” (or the like) precede a term, the term is to be construed as disclosing “about”/“approximately”/“substantially” the term as well as the term without modification by “about”/“approximately”/“substantially”—for example, “about 10 wt. %” discloses “9 wt. % to 11 wt. %” as well as discloses “10 wt. %.” When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The phrase “at least a portion of” in regard to a composition means from about 0.1 wt % to about 100 wt % of the composition.

The term “aromatics” as used herein is synonymous with “aromates” and means both cyclic aromatic hydrocarbons that do not contain heteroatoms as well as heterocyclic aromatic compounds. The term includes monocyclic, bicyclic and polycyclic ring systems (collectively, such bicyclic and polycyclic ring systems are referred to herein as “polycyclic aromatics” or “polycyclic aromates”). The term also includes aromatic species with alkyl groups and cycloalkyl groups. Thus, aromatics include, but are not limited to, benzene, azulene, heptalene, phenylbenzene, indacene, fluorene, phenanthrene, triphenylene, pyrene, naphthacene, chrysene, anthracene, indene, indane, pentalene, and naphthalene, as well as alkyl and cycloalkyl substituted variants of these compounds. In some embodiments, aromatic species contains 6-14 carbons, and in others from 6 to 12 or even 6-10 carbon atoms in the ring portions of the groups. The phrase includes groups containing fused rings, such as fused aromatic-aliphatic ring systems (e.g., indane, tetrahydronaphthene, and the like).

As used herein, the term “C#,” wherein “#” is a positive integer, is meant to describe all hydrocarbons having # carbon atoms. Accordingly, the term “C#+ hydrocarbons” is meant to describe all hydrocarbon molecules having # or more carbon atoms. For example, the term “C5+” describes a mixture of hydrocarbons with 5 or more carbon atoms; the term “C4−” describes a mixture of hydrocarbons with 4 carbon atoms, 3 carbon atoms, 2 carbon atoms, 1 carbon atom, and/or 0 carbon atoms (i.e., H₂).

A “diesel” in general refers to a fuel with a boiling point at atmospheric pressure that falls in the range from about 150° C. to about 360° C. (the “diesel boiling range”).

A “gasoline” in general refers to a fuel for spark-ignition engines with a boiling point that falls in the range from about 35° C. to about 225° C. An “aromatic gasoline” refers to a gasoline that includes aromatics. Thus, while the phrase “the aromatic gasoline is obtained from C5+ to 221° C. cut point” will be understood by persons of ordinary skill in the art, in the event the phrase could be deemed not clear to persons of ordinary skill in the art the phrase will be understood to mean “the aromatic gasoline is obtained from 35° C. to 221° C. cut point.”

The term “olefin” is used herein refers to an unsaturated hydrocarbon compound containing at least one carbon-carbon double bond. The term “light olefins” relates to ethylene, propylene, butylene (e.g., 1-butene, cis-2-butene, trans-2-butene, and/or isobutylene), and/or butadiene.

The term “paraffins” as used herein means non-cyclic, branched or unbranched alkanes. An unbranched paraffin is an n-paraffin; a branched paraffin is an iso-paraffin. “Cycloparaffins” are cyclic, branched or unbranched alkanes.

The term “paraffinic” as used herein means both paraffins and cycloparaffins as defined above as well as predominantly hydrocarbon chains possessing regions that are alkane, either branched or unbranched, with or without mono- or di-unsaturation (i.e., one or two double bonds).

A “petroleum-based feedstock” as used herein refers to a hydrocarbon-containing composition that includes components ultimately produced by humans from natural gas and/or crude oil (e.g., in a crude oil refining facility) such as a vacuum gas oil, an atmospheric residue, a vacuum residue, a hydrotreated straight-run diesel, a hydrotreated fluidized catalytic cracker light cycle oil, a hydrotreated coker light gasoil, and/or a hydrocracked FCC heavy cycle oil. A “petroleum-based feedstock” in any embodiment described herein may or may not include (in addition to a component ultimately produced from crude oil) a “biorenewable feedstock,” and/or a “plastics-derived feedstock.” A “biorenewable feedstock” as used herein is a component not ultimately produced by humans from crude oil and may include animal fats, animal oils, plant fats, plant oils, vegetable fats, vegetable oils, greases, pyrolysis oils produced from biological materials, or mixtures of any two or more thereof. A “plastics-derived feedstock” may include oil from thermal or catalytic conversion of plastics.

### The Present Technology

With gasoline engine-powered cars being replaced by electric vehicles, the demand for catalytic cracking (e.g., Fluid Catalytic Cracking (FCC)) gasoline as a transportation fuel is expected to decrease dramatically. At a point, catalytic cracking operations such as FCC—the main gasoline production machine in current refinery settings-will no longer be viable without significant changes in product yield structure through either unit hardware revamp or catalyst changes.

Even before the anticipated decreasing demand for gasoline as fuel in the future, the increasing demand for propylene as a petrochemical feedstock while concurrently balancing gasoline fuel production for gasoline engines has resulted in the installation of an increasing number of higher severity FCC units. Compared to traditional FCC units, the higher severity units generally operate at lower weight hourly space velocity (WHSV), higher catalyst to oil ratio (C/O), higher reactor outlet temperatures, and a higher steam rate. These features are illustrated in Table 1 below. To further maximize propylene yield, it is common for refiners to recycle a portion of the gasoline, typically light cut naphtha (LCN), to the reactor to be re-cracked. To achieve lower WHSV, the Deep Catalytic Cracking (DCC) process utilizes a bed of fluidized catalyst, downstream of the riser, while the Ultimate Catalytic Cracking (UCC) process (e.g., as described in U.S. Pat. No. 5,846,402) utilizes a very high catalyst circulation rate and hence high catalyst hold-up in the riser.

TABLE 1
Comparison of various catalytic cracking processes

| | FCC | DCC | UCC |
|---|---|---|---|
| WHSV, 1/h | 125 to 200 | 0.2 to 20 | 40 to 120 |
| Cat to Oil Ratio | 4 to 8 | 2 to 12 | 15 to 25 |
| Riser Outlet Temperature, ° C. | 490 to 540 | 540 to 625 | 530 to 600 |
| Steam, wt % Feed | 0 to 10 | 5 to 50 | 3 to 50 |
| Propylene yield, wt % | 4 to 10 | 13-20 | 13-20 |

Catalysts for DCC and UCC processes are typically different from FCC catalysts. For example, U.S. Pat. No. 5,846,402, U.S. Patent Application No. 2010/021310A1, and U.S. U.S. Pat. No. 9,365,779 discuss the use of a catalyst with the composition illustrated in Table 2 (below) in combination with the conditions of the UCC process to maximize light olefins.

TABLE 2
Catalyst compositions of U.S. Pat. No. 5,846,402, US Patent
Application 2010/0213102A1, and U.S. Pat. No. 9,365,779

| | | | FCC/UCC |
|---|---|---|---|
| | UCC Catalyst | UCC Catalyst | Catalyst |
| | U.S. Pat. No. | US | U.S. Pat. No. |
| | 5,846,402 | 2010/0213102A1 | 9,365,779 |
| Y-zeolite | 1 wt %-6 wt % | 0 wt %-25 wt % | 12 wt %-60 wt % |
| ZSM-5 | 8 wt %-25 wt % | 0.5 wt %-50 wt % | 10 wt %-28 wt % |
| Bottoms Active | 0 wt %-8 wt % | — | — |
| Component | | | |
| Rare Earth | 0 wt %-1 wt % | — | — |
| Oxide | | | |
| Non-Active | 60 wt %-91 wt % | — | — |
| Component and | | | |
| Binder | | | |

While the main objective of the processes disclosed in the above references is to generate high yields of propylene and light olefins, unrecognized was the inventors' presently-identified need for increasing gasoline aromatics so that the gasoline stream can be used as a chemical feedstock. In fact, a high concentration of aromatics—especially benzene—is considered undesirable for current gasoline specifications in many parts of the world due to health concerns. Therefore, prior to the present application, the art focused on increasing light olefins yield while maintaining relatively high gasoline yields and relatively low aromatics concentrations in gasoline.

The inventors of the present technology discovered that simultaneously adjusting operation conditions of a catalytic cracking process, such as temperature, catalyst to oil ratio (“C/O”), and weight hourly space velocity (“WHSV”), and catalyst composition (e.g., Y-zeolite content, ZSM-5 content, and ratio of Y-zeolite to ZSM-5 content) leads to significant and advantageous changes in product composition. A further advantage provided by the present technology is that by producing a more aromatic gasoline, more feedstock hydrogen may shifted to a C4− fraction, thus increasing the yield of light olefins.

In particular, it was unexpectedly discovered that a catalytic cracking process including lower WHSV and including catalysts having higher Y-zeolite and ZSM-5 content than those described by U.S. Pat. Nos. 5,846,4402 and 9,365,779 produced higher yields of light olefins and produced gasolines with a higher concentration of aromatics. Specifically, use of catalyst compositions containing 0 wt % to 15 wt % Y-type zeolite, greater than 30 wt % ZSM-5, and a ZSM-5 to Y-type zeolite weight ratio greater than 3 in a process utilizing a weight hourly space velocity (WHSV) from 40 h⁻¹ to 120 h⁻¹ results in a product where equal to or greater than 60% (e.g., equal to or greater than 63%) of the hydrogen content of the petroleum-based feedstock (“feed hydrogen”) may be redistributed to a C4− fraction of the product, equal to or less than 28% (e.g., equal to or less than 25%) of the feed hydrogen may be redistributed to the aromatic gasoline of the product, and the atomic ratio of hydrogen to carbon in the aromatic gasoline may be equal to or less than 1.46:1 (e.g., equal to or less than 1.40:1). Additionally, it was discovered that catalyst compositions with higher than 50 wt % ZSM-5 and lower amounts of Y-type zeolite (including, e.g., exclusion of a Y-type zeolite) advantageously maximize ethylene yield and the amount of aromatics in the aromatic gasoline as well as provide relatively high yields of propylene, butylene, light cycle oil (“LCO”; a type of diesel), and/or fuel oil.

The above unexpected discoveries afford a catalytic cracking process for producing high yields of light olefins (e.g., ethylene, propylene, and/or butylene) and aromatics in an aromatic gasoline (e.g., benzene, toluene, and/or xylene) from a petroleum-based feedstock. The process also has the flexibility of producing high yields of LCO and fuel oil if needed while maintaining high yields of light olefins and highly aromatic gasoline as valuable feedstocks for the petrochemical industry. The process features a single riser configuration, as almost all existing FCC units are currently configured, optionally without the need for bed cracking and/or product recycle. Therefore, the present disclosure enables revamp of existing catalytic cracking units with relatively low capital cost.

In an aspect, the present technology provides a catalytic cracking process for producing light olefins and aromatic gasoline, the process includes contacting a petroleum-based feedstock with a catalyst in a single riser reactor at a temperature and a weight hourly space velocity (WHSV) to convert at least a portion of the petroleum-based feedstock into light olefins and aromatic gasoline, where the temperature is from about 530° C. to about 600° C., the WHSV is from about 40 h⁻¹ to about 120 h⁻¹. The catalyst includes 0 wt % to about 15 wt % of a Y-type zeolite and greater than 30 wt % of a pentasil zeolite, where a weight ratio of the pentasil zeolite to the Y-type zeolite is greater than 3, and a weight ratio of catalyst to petroleum-based feedstock is from about 10:1 to about 30:1, optionally from about 13:1 to about 25:1, and the aromatic gasoline is obtained from C5+ to 221° C. cut point. Thus, in any embodiment of the present technology, the weight ratio of catalyst to petroleum-based feedstock may be about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, or any range including and/or in between any two of these values. In any embodiment of the present technology, the light olefins may include ethylene, propylene, butadiene, 1-butene, cis-2-butene, trans-2-butene, and/or isobutylene. In any embodiment of the present technology, the aromatic gasoline may include benzene, toluene, xylene, ethylbenzene, trimethyl benzene, methylethylbenzene, and/or propylbenzene.

The pentasil zeolite contains silicon and oxygen as elements constituting the framework and may be a crystalline silica whose framework is substantially composed of silicon and oxygen, or may be a crystalline metallosilicate which further contains another metal element as an element constituting the framework. In the case of the crystalline metallosilicate, examples of such a metal element other than silicon and oxygen include but are not limited to Be, B, Al, Ti, V, Cr, Fe, Co, Ni, Cu, Zn, Ga, Ge, Zr, Nb, Sb, La, Hf, Bi, or a mixture of any two or more thereof. In any embodiment of the present technology, the pentasil zeolite may be a ZSM-type zeolite, such as ZSM-5 and/or ZSM-11. See, e.g., U.S. Pat. Nos. 3,308,069; 3,702,886; 3,709,979; 3,832,449; 4,016,245; 4,788,169; 3,941,871; 5,013,537; 4,851,602; 4,564,511; 5,137,706; 4,962,266; 4,329,328; 5,354,719; 5,365,002; 5,064,793; 5,409,685; 5,466,432; 4,968,650; 5,158,757; 5,273,737; 4,935,561; 4,299,808; 4,405,502; 4,363,718; 4,732,747; 4,828,812; 5,466,835; 5,374,747; and 5,354,875. In any embodiment of the present technology, the pentasil zeolite may be stabilized with P₂O₅. In any embodiment of the present technology, the weight ratio of P₂O₅ to the pentasil zeolite may be about 0.1:1, about 0.2:1, about 0.3:1, or any range including and/or in between any two of these values. In any embodiment of the present technology, the catalyst may include about 35 wt % to about 60 wt % of the pentasil zeolite; thus, in any embodiment of the present technology, the catalyst may include the pentasil zeolite in an amount of about 35 wt %, about 40 wt %, about 45 wt %, about 50 wt %, about 55 wt %, about 60 wt %, or any range including and/or in between any two of these values. For example, in any embodiment the catalyst may include about 35 wt % to about 55 wt % pentasil zeolite. In any embodiment herein, the catalyst may include about 6 wt % to about 24 wt % phosphorus (measured as P₂O₅); thus, in any embodiment of the present technology, the catalyst may include phosphorus in an amount of about 6 wt %, about 8 wt %, about 10 wt %, about 12 wt %, about 14 wt %, about 16 wt %, about 18 wt %, about 20 wt %, about 22 wt %, about 24 wt %, or any range including and/or in between any two of these values. In any embodiment herein, the catalyst may include about 1 wt % to about 10 wt % iron (measured as Fe₂O₃); thus, in any embodiment of the present technology, the catalyst may include iron in an amount of about 1 wt %, about 2 wt %, about 3 wt %, about 4 wt %, about 5 wt %, about 6 wt %, about 7 wt %, about 8 wt %, about 9 wt %, about 10 wt %, or any range including and/or in between any two of these values.

Suitable Y-type zeolites include those typically used in catalytic cracking processes (e.g., FCC). These zeolites include, but are not limited to, Y zeolite (see, e.g., U.S. Pat. No. 3,130,007); ultrastable Y zeolite (USY) (see, e.g., U.S. Pat. No. 3,449,070); rare earth exchanged Y (REY) (see, e.g., U.S. Pat. No. 4,415,438); rare earth exchanged USY (REUSY); dealuminated Y (DeAlY) (see, e.g., U.S. Pat. Nos. 3,442,792; 4,331,694); ultrahydrophobic Y (UHPY) (see, e.g., U.S. Pat. No. 4,401,556), and combinations of any two or more thereof, where typically in the art such Y-type zeolites are collectively all referred to as a “a Y zeolite” or “Y zeolites.” Suitable Y-type zeolites may be large-pore molecular sieves having pore sizes greater than about 7 Angstroms; in current commercial practice most cracking catalysts contain such zeolites. In any embodiment of the present technology, the catalyst may include a Y-type zeolite in an amount of about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, or any range including and/or in between any two of these values. For example, in any embodiment of the present technology, the catalyst may include no Y-type zeolite or may include about 1 wt % to about 8 wt % of Y-type zeolite. In any embodiment of the present technology, the Y-type zeolite may be stabilized with a rare earth oxide (referred to herein and in the claims as “RE₂O₃”) such as a lanthanum oxide and/or a cerium oxide. In any embodiment of the present technology, the catalyst may include a weight ratio of RE₂O₃ to Y-type zeolite of about 0.04:1 to about 0.15:1; thus, in any embodiment of the present technology, the catalyst may include a weight ratio of RE₂O₃ to Y-type zeolite of about 0.04:1, about 0.05:1, about 0.06:1, about 0.07:1, about 0.08:1, about 0.09:1, about 0.10:1, about 0.11:1, about 0.12:1, about 0.13:1, about 0.14:1, about 0.15:1, or any range including and/or in between any two of these values.

In any embodiment of the present technology, the WHSV may be about 40 h⁻¹, about 45 h⁻¹, about 50 h⁻¹, about 55 h⁻¹, about 60 h⁻¹, about 65 h⁻¹, about 70 h⁻¹, or any range including and/or in between any two of these values.

Contacting the petroleum-based feedstock with the catalyst may, in any embodiment of the present technology, redistribute a hydrogen content of the petroleum-based feedstock by converting at least a portion of the petroleum-based feedstock to products, such products including the light olefins and the aromatic gasoline. In any embodiment of the present technology, equal to or greater than 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% (or any range including and/or in between any two of these values) of the hydrogen content of the petroleum-based feedstock may be redistributed to C4− products. In any embodiment of the present technology, equal to or less than 28%, 27%, 26%, 25%, 24%, 23%, 22%, 21%, 20%, 19%, 18%, 17%, 16%, 15%, or 14% (or any range including and/or in between any two of these values) of the hydrogen content of the petroleum-based feedstock may be redistributed to the aromatic gasoline.

In any embodiment of the present technology, an atomic ratio of H to C (also referred to herein as the “atomic H:C ratio”) in the aromatic gasoline may be equal to or less than 1.46:1, 1.45:1, 1.44:1, 1.43:1, 1.42:1, 1.41:1, 1.40:1, 1.40:1, 1.39:1, 1.38:1, 1.37:1, 1.36:1, 1.35:1, 1.34:1, 1.33:1, 1.32:1, 1.31:1, or 1.30:1 (or may be any range including and/or in between any two of these values).

In any embodiment of the present technology, the process may include or exclude bed cracking. In any embodiment of the present technology, the process may include or exclude product recycle.

In any embodiment of the present technology, the petroleum-based feedstock may include vacuum gas oil, atmospheric gas oil, coker gas oil, deasphalted oil, atmospheric resid, vacuum residue, or a mixture of any two or more thereof. In any embodiment of the present technology, the petroleum-based feedstock may include a coal liquefied oil, tar sand oil, shale oil, a biorenewable feedstock, a plastics-derived feedstock, or a mixture of any two or more thereof. In any embodiment of the present technology, the biorenewable feedstock may include animal fats, animal oils, plant fats, plant oils, vegetable fats, vegetable oils, greases, pyrolysis oils produced from biological materials, or mixtures of any two or more thereof.

In any embodiment of the present technology, contacting the petroleum-based feedstock with the catalyst may convert at least a portion of the petroleum-based feedstock into a dry gas, a liquefied petroleum gas (LPG), a light cycle oil (LCO), a slurry, or a combination of any two or more thereof. In any embodiment of the present technology, the light olefins may be included in the dry gas and/or the LPG. In any embodiment of the present technology, the process may further include one or more fractionation steps to fractionate the dry gas and/or LPG to yield ethylene, propylene, and/or butylene. In any embodiment of the present technology, the process may further include one or more fractionation steps to fractionate the aromatic gasoline to yield benzene, toluene, xylene, ethylbenzene, trimethylbenzene, methylethylbenzene, and/or propylbenzene.

The present technology, thus generally described, will be understood more readily by reference to the following examples, which are provided by way of illustration and are not intended to be limiting of the present technology

### EXAMPLES

### Example 1

Two comparative catalysts (Catalyst 1 and Catalyst 2) were synthesized according to the teachings of U.S. Pat. No. 5,846,402 (“the '402 patent”), whereas Catalyst 3, Catalyst 4, and Catalyst 5 are examples according to the present technology. Table 3 provides the amounts of components utilized for each catalyst. For each catalyst, the “bottoms cracking matrix” was provided via use of pseudoboehmite in the range of 3 to 11% (as indicated in Table 3) in generating the catalysts, the Y-zeolite was stabilized with rare earth, and the ZSM-5 was stabilized with phosphorus where the P₂O₅/ZSM-5 weight ratio was kept constant at 0.25 for all the catalysts.

Regarding the comparative catalysts, comparative Catalyst 1 is in the preferred range of the formulation window disclosed in the '402 patent while comparative Catalyst 2 is on the upper range of Y-zeolite, ZSM-5, and rare earth specifications claimed by the '402 patent.

Notably, each of Catalysts 3-5 utilize greater than 28 wt % ZSM-5 where the total amount of Y-zeolite plus ZSM-5 (“Total ZSM-5+Y” in Table 3) was higher than 35 wt %. Further, for each of Catalysts 3-5 the amount of clay and binder utilized was less than 45 wt %, lower than the amount specified by the '402 patent. In addition, Catalyst 3 included about 8 wt % Y-zeolite-thus, above the range described for the invention of the '402 patent related to this component.

TABLE 3
Catalyst Formulations

| | | Catalyst 1 | Catalyst 2 | | | |
|---|---|---|---|---|---|---|
| Catalyst Formulation | UCC | (Comparative) | (Comparative) | Catalyst 3 | Catalyst 4 | Catalyst 5 |
| Y-zeolite | 1-6% | 4 | 6 | 8 | 6 | 0 |
| ZSM-5 | 8-25% | 16 | 25 | 39 | 41 | 55 |
| Bottoms Cracking Matrix | 0-8% | 6 | 10 | 11 | 10 | 3 |
| RE₂O₃ | 0-1% | 0.3 | 0.9 | 0.6 | 0.9 | 1.0 |
| Clay + Binder + P₂O₅ | 91-60% | 73.7 | 58.1 | 41.4 | 42.1 | 41 |
| Total ZSM-5 + Y | 9 to 31% | 20 | 31 | 46 | 47 | 55 |
| P₂O₅/ZSM-5 | N/A | 0.25 | 0.25 | 0.25 | 0.25 | 0.25 |
| ZSM-5/Y-zeolite | N/A | 4 | 4.2 | 4.9 | 6.8 | N/A |

### Example 2

Catalysts 1-3 were utilized for cracking a U.S. mid-continent VGO in a circulating pilot plant operating at UCC conditions (see Table 1), where the riser outlet temperature was 1050° F. (566° C.), the C/O maintained at 16; and the WHSV maintained at about 59 h⁻¹ to about 61 h⁻¹. Properties of the mid-continent VGO used in this Example (as well as Examples 3-4) are provided in Table 4; the results are shown in Table 5.

TABLE 4
Properties of the mid-continent VGO feedstock

| Test | Unit | Results |
|---|---|---|
| API | | 24.03 |
| Specific Gravity | | 0.9098 |
| Arom Ring Carbons, Ca | wt % | 19.6 |
| Napthenic Ring Carbons, Cn | wt % | 18.3 |
| Paraffinic Carbons, Cp | wt % | 62.1 |
| Hydrogen | wt % | 12.5 |
| Sulfur | wt % | 0.5 |
| Basic Nitrogen | wt % | 0.05 |
| Total Nitrogen | wt % | 0.14 |
| Conradson Carbon | wt % | 0.4 |
| Distillation, Initial Boiling Point | ° F. | 587 |
| Distillation, 5% | ° F. | 671 |
| Distillation, 10% | ° F. | 703 |
| Distillation, 20% | ° F. | 746 |
| Distillation, 30% | ° F. | 780 |
| Distillation, 40% | ° F. | 811 |
| Distillation, 50% | ° F. | 844 |
| Distillation, 60% | ° F. | 879 |
| Distillation, 70% | ° F. | 919 |
| Distillation, 80% | ° F. | 961 |
| Distillation, 90% | ° F. | 1016 |
| Distillation, 95% | ° F. | 1059 |
| Distillation, End Point | ° F. | 1153 |
| Recovery from Distillation | % | 99.6 |

TABLE 5
Comparison of yields at constant catalyst-oil ratio

| | | | Catalyst 1 | Catalyst 2 | |
|---|---|---|---|---|---|
| | | | (Compar- | (Compar- | |
| | UCC | | ative) | ative) | Catalyst 3 |
| Reaction | | | | | |
| Conditions | | | | | |
| WHSV | 40-120 | | 59 | 59 | 61 |
| C/O | 15-25 | | 16 | 16 | 16 |
| ROT | 530-600 | C. | 566 | 566 | 566 |
| Pressure (g) | 1-4 | kg/cm2 | 1.4 | 1.4 | 1.4 |
| Steam, % of Feed | 3 to 50 | | 8.7 | 8.7 | 8.7 |
| Yields, wt % feed | | | | | |
| C2 = wt % | | | 4.7 | 5.0 | 7.1 |
| C3 = wt % | | | 19.8 | 20.8 | 22.5 |
| C4 = wt % | | | 16.4 | 16.2 | 16.1 |
| Gasoline wt % | | | 28.2 | 28.2 | 26.3 |
| Gasoline | | | 66.0 | 73.6 | 77.8 |
| Aromatics | | | | | |
| LCO/Diesel wt % | | | 13.4 | 11.3 | 11.2 |
| Fuel Oil wt % | | | 5.6 | 4.1 | 4.7 |

As shown in Table 5, Catalyst 3 of the present technology provided higher yields of ethylene and propylene than the comparative catalysts (Catalysts 1 and 2). Moreover, Catalyst 3 produced gasoline with a higher concentration of aromatics than the gasoline provided by Catalyst 1 and Catalyst 2.

### Example 3

Catalysts 1, 4, and 5 were utilized cracking a U.S. mid-continent VGO (see Table 4) in a circulating pilot plant operating at UCC conditions (see Table 1), where the riser outlet temperature was 1050° F. (566° C.), the C/O maintained at 13.8, and the WHSV maintained in the range of about 68 h⁻¹ to about 70 h⁻¹. The results are shown in Table 6.

As illustrated in Table 6, use of Catalyst 4 provided higher yields of ethylene and propylene as compared to when Catalyst 1 was used. Catalyst 4 also produced gasoline with a higher concentration of aromatics than the gasoline provided by Catalyst 1.

The results provided by using Catalyst 5 are illustrative of the flexibility provided by the present technology: to shift the yields of light olefins and/or gasoline towards diesel and/or fuel oil while concurrently still advantageously providing gasoline with a relatively high concentration of aromatics. In particular, use of Catalyst 5 provided significantly higher yield of LCO/diesel and fuel oil as compared to Catalyst 1 and Catalyst 4 while concurrently providing a higher yield of ethylene than Catalyst 1 (as well as higher than provided by Catalyst 4). Further, Catalyst 5 provided gasoline with a similar aromatics concentration as the gasoline provided with Catalyst 4. Moreover, the selectivity of ethylene and propylene can be adjusted by changing the ratio of Y-zeolite to ZSM-5.

TABLE 6
Comparison of yields at constant catalyst-oil ratio

| | | | Catalyst 1 | | |
|---|---|---|---|---|---|
| | | | (Compar- | | |
| | UCC | | ative) | Catalyst 4 | Catalyst 5 |
| Reaction | | | | | |
| Conditions | | | | | |
| WHSV | 40-120 | | 69 | 70 | 70 |
| C/O | 15-25 | | 14 | 14 | 14 |
| ROT | 530-600 | C. | 566 | 566 | 566 |
| Pressure (g) | 1-4 | kg/cm2 | 1.4 | 1.4 | 1.4 |
| Steam, % of Feed | 3 to 50 | | 8.7 | 8.7 | 8.7 |
| Yields, wt % feed | | | | | |
| C2 = wt % | | | 4.7 | 6.5 | 7.9 |
| C3 = wt % | | | 18.9 | 21.2 | 15.2 |
| C4 = wt % | | | 15.4 | 15.0 | 9.6 |
| Gasoline wt % | | | 29.1 | 26.5 | 18.5 |
| Gasoline | | | 64.9 | 77.6 | 77.6 |
| Aromatics | | | | | |
| LCO/Diesel wt % | | | 13.9 | 12.4 | 18.2 |
| Fuel Oil wt % | | | 6.0 | 4.7 | 16.5 |

### Example 4

In the patent literature, both DCC and UCC technologies purport to achieve greater than 20 wt % propylene yield by cracking a “VGO” feedstock-yet there are a variety of different VGO feedstocks. Due to lab-to-lab variability in the properties of the VGO, a person of ordinary skill in the art appreciates one cannot directly compare product yields from different laboratories even if all other process conditions are purportedly kept the same. The properties of the feedstock strongly influence the amount of LPG olefins that can be produced. Typically, a FCC feedstock contains about 12 wt % to about 13 wt % H (or a H/C atomic ratio between about 1.64 and about 1.8). Yet ethylene, propylene, 1-butene, cis-2-butene, trans-2-butene, and isobutylene each have a H/C atomic ratio of 2. Hence the production of such light olefins is limited by the hydrogen content of the feedstock. In general, as the hydrogen content increases, the conversion increases and the yields of propylene and butylene increase. For example, a higher propylene yield may be obtained by cracking a highly paraffinic VGO feed (with hydrogen content greater than 13 wt %) whereas the same process—same conditions, same reactor, same catalyst, etc.—will provide a much lower propylene yield when cracking a mid-continent VGO feed (with hydrogen content of ˜12.5 wt %). The FCC process causes a shift in the carbon distribution from higher molecular weight feedstock to lower molecular weight products. Less appreciated in the scientific literature is the fact that shift in hydrogen distribution to the lower molecular weight products is even more dramatic than the shift in the carbon distribution. This is because the H/C ratio increases as the molecular weight decreases. Instead, in order to allow for an appropriate comparison, one should use the hydrogen distribution of cracked products on feed basis.

Accordingly, Table 7 shows the hydrogen distribution of cracked products, on a feed hydrogen basis, of a representative maximum gasoline FCC operation (catalyst with 25 wt % Y-zeolite and no ZSM-5, 521° C., WHSV=120 h⁻¹), a current state of the art maximum propylene FCC operation (catalyst with 18 wt % Y-zeolite and 17 wt % ZSM-5, 566° C., WHSV=120 h⁻¹), and an operation according to the present technology (Catalyst 3 with 8 wt % Y-zeolite and 39 wt % ZSM-5; 566° C. WHSV=57 h⁻¹). All data are generated by a single riser cracking of the same mid-continent VGO (see Table 4) without bed cracking or product recycle. The elemental hydrogen content of the dry gas and LPG streams was directly calculated based on the molecular formulas of the components in these streams and their weight percentages; the hydrogen content of gasoline, LCO and slurry was determined by ASTM5291 “Standard Test Methods for Instrumental Determination of Carbon, Hydrogen, and Nitrogen in Petroleum Products and Lubricants” where the liquid product was physically distilled into gasoline (59 (15° C.)−430° F. (221° C.) as the boiling point range) and LCO (430 (221° C.)−700° F. (371° C.) as the boiling point range) with the left-over at the bottom of the distillation column as the slurry fraction. Elemental hydrogen content of the coke was calculated from the CO, CO₂, and O₂ analysis of the pilot plant regenerator flue gas, where the elemental hydrogen was reacted with oxygen to form water and therefore can be calculated as the missing part of the oxygen when compare the total output of oxygen in CO, CO₂, and remaining O₂, to the total oxygen of the inlet air. The result of hydrogen balance from all disclosed pilot plant testing was >96% recovery of the hydrogen content of the VGO feed (see Table 4).

In the maximum gasoline FCC operation, 57.1% of the feed hydrogen ends up in the gasoline range, 27.5% of the feed hydrogen ends up in the LPG (C3+C4) and only 3.3% of the feed hydrogen ends up in dry gas (C2−). The total hydrogen in the C4− range (LPG+dry gas) is 30.8%.

In the current state of the art maximum propylene FCC operation, the hydrogen distribution shifts away from gasoline and towards LPG and dry gas, resulting in about half as much feed hydrogen (28.2%) ending up in the gasoline range and about twice as much feed hydrogen (60.2%) in the C4− range as compared to the max gasoline FCC operation.

The operation utilizing Catalyst 3 (combining lower WHSV with a catalyst of the present technology directed toward enhancing light olefin production) exhibits further shifting of feed hydrogen from the gasoline to the C4− range: the feed hydrogen content in gasoline is further lowered to 20.9% and the feed hydrogen content of C4− is further increased to 67.6%.

Table 7 also provides the atomic ratio of hydrogen to carbon (also referred to in this disclosure as “atomic ratio of H/C”, “atomic H/C ratio”, or simply “H/C”) for the various product streams. Desired products in the C4− fraction include ethylene (C₂H₄), propylene (C₃H₆) and butylene (C₄H₈), each of which have atomic H/C ratio of 2, as well as butadiene (C₄H₆) with an atomic H/C ratio less than 2. Undesirable products include H₂, methane, ethane, propane, and butane, each of which have an atomic H/C ratio greater than 2. The operation utilizing Catalyst 3 provides lower dry gas and LPG atomic H/C ratios than the maximum propylene FCC process and much lower than the maximum gasoline FCC process. In fact, the LPG atomic H/C ratio provided from the operation utilizing Catalyst 3 is very close to 2, evidencing that the LPG is highly olefinic. Without being bound by theory, it is believed the combination of Catalyst 3 and the operating conditions minimize the hydrogen transfer reactions thus resulting in a highly olefinic C4− stream.

The atomic H/C ratio of gasoline is a good indicator for the degree of aromaticity. Table 8 shows that H/C for benzene (C₆H₆) is 1, but with increasing substitution with alkyl (methyl, ethyl, or propyl) groups the atomic H/C ratio increases. Furthermore, the gasoline atomic H/C ratios increase with increasing levels of non-aromatic compounds, such as paraffins, olefins, and naphthenes—in a cracking process, these represent compounds that could have been cracked into light olefins but were not. The operation utilizing Catalyst 3 provides gasoline with lower atomic H/C ratios than the gasoline of the maximum propylene FCC operation and much lower than the gasoline H of the maximum gasoline FCC operation, evidencing that the present technology provides a very effective conversion of non-aromatic molecules into light olefins. Indeed, the atomic H/C ratio for the gasoline provided by the operation utilizing Catalyst 3 is only 1.33 (note, trimethylbenzene has an atomic H/C ratio of 1.33), where the aromatic compounds of the gasoline are highly valuable for use as a petrochemical feedstock.

TABLE 7
Hydrogen distribution in cracked product

| | Max Gasoline | Max Propylene | Present |
|---|---|---|---|
| | FCC | FCC | Technology |
| | 25% Y, 0% ZSM-5, | 18% Y, 17% ZSM-5, | 8% Y, 39% ZSM-5, |
| | 521° C., 120 | 566° C., 120 | 566° C., 57 |
| | 1/h WHSV | 1/h WHSV | 1/h WHSV |
| Y-Zeolite | 25 | 18 | 8 |
| ZSM-5 | 0 | 17 | 39 |
| Temperature/C. | 521 | 566 | 566 |
| WHSV, h − 1 | 120 | 120 | 57 |
| Dry Gas H wt % Feed H | 3.3 | 11.8 | 15.3 |
| LPG H wt % Feed H | 27.5 | 48.5 | 52.2 |
| Gasoline H wt % Feed H | 57.1 | 28.2 | 20.9 |
| LCO H wt % Feed H | 8.1 | 7.8 | 7.5 |
| Slurry H wt % Feed H | 1.3 | 2.2 | 2.4 |
| Coke H wt % Feed H | 2.7 | 1.6 | 1.7 |
| wt % H in C4− | 30.8 | 60.2 | 67.6 |
| wt % H in gasoline and lighter | 87.9 | 88.5 | 88.5 |
| Dry Gas C wt % Feed C | 1.6 | 6.0 | 8.6 |
| LPG C wt % Feed C | 19.3 | 34.6 | 38.0 |
| Gasoline C wt % Feed C | 46.6 | 28.6 | 23.4 |
| LCO C wt % Feed C | 11.5 | 11.0 | 10.5 |
| Slurry C wt % Feed C | 2.4 | 4.0 | 4.4 |
| Coke C wt % Feed C | 6.0 | 3.5 | 2.5 |
| wt % C in LPG and lighter | 20.9 | 40.5 | 46.7 |
| wt % C in gasoline and lighter | 67.5 | 69.2 | 70.1 |
| Dry gas H/C Ratio | 3.19 | 2.90 | 2.67 |
| LPG H/C Ratio | 2.16 | 2.09 | 2.08 |
| Gasoline H/C ratio | 1.87 | 1.46 | 1.33 |
| LCO H/C ratio | 1.09 | 1.05 | 1.07 |
| Slurry H/C ratio | 0.91 | 0.81 | 0.82 |
| Coke H/C ratio | 0.61 | 0.67 | 1.01 |

TABLE 8
Atomic H/C ratio of various aromatic compounds in gasoline

| Empirical Formula | Example | H/C |
|---|---|---|
| C₆H₆ | Benzene | 1 |
| C₇H₈ | Toluene | 1.14 |
| C₈H₁₀ | Xylene, ethylbenzene | 1.25 |
| C₉H₁₂ | Trimethylbenzene, cumene | 1.33 |

Para. 1. A catalytic cracking process for producing light olefins and aromatic gasoline, the process comprising:
contacting a petroleum-based feedstock with a catalyst in a single riser reactor at a temperature and a weight hourly space velocity (WHSV) to convert at least a portion of the petroleum-based feedstock into light olefins and aromatic gasoline;
wherein:
the catalyst comprises
0 wt % to about 15 wt % of a Y-type zeolite, and
greater than 30 wt % of a pentasil zeolite,
where a weight ratio of the pentasil zeolite to the Y-type zeolite is greater than 3;
the temperature is from about 530° C. to about 600° C.;
the WHSV is from about 40 h⁻¹ to about 120 h⁻¹;
a weight ratio of catalyst to petroleum-based feedstock is from about 10:1 to about 30:1,
optionally from about 13:1 to about 25:1; and
the aromatic gasoline is obtained from C5+ to 221° C. cut point.

Para. 2. The process of claim 1, wherein the light olefins comprise ethylene, propylene, butylene, or a combination of any two or more thereof.

Para. 3. The process of Para. 1 or Para. 2, wherein the aromatic gasoline comprises benzene, toluene, xylene, ethylbenzene, trimethylbenzene, methylethylbenzene, propylbenzene, or a combination of any two or more thereof.

Para. 4. The process of any one of Paras. 1-3, wherein the pentasil zeolite comprises ZSM-5.

Para. 5. The process of any one of Paras. 1-4, wherein the pentasil zeolite is stabilized with P₂O₅, optionally wherein a weight ratio of P₂O₅ to the pentasil zeolite is from about 0.1:1 to about 0.3:1.

Para. 6. The process of any one of Paras. 1-5, wherein the Y-type zeolite is stabilized with RE₂O₃, optionally wherein a weight ratio of RE₂O₃ to the Y-type zeolite is about 0.04:1 to about 0.15:1.

Para. 7. The process of any one of Paras. 1-6, wherein the catalyst comprises 0 wt % to about 10 wt % of the Y-type zeolite.

Para. 8. The process of any one of Paras. 1-7, wherein the catalyst comprises about 35 wt % to about 60 wt % of the pentasil zeolite.

Para. 9. The process of any one of Paras. 1-8, wherein the WHSV is from about 40 h⁻¹ to about 70 h⁻¹.

Para. 10. The process of any one of Paras. 1-9, wherein contacting the petroleum-based feedstock with the catalyst redistributes a hydrogen content of the petroleum-based feedstock by converting at least a portion of the petroleum-based feedstock to products, the products comprising the light olefins and the aromatic gasoline.

Para. 11. The process of Para. 10, wherein equal to or greater than 60% of the hydrogen content of the petroleum-based feedstock is redistributed to C4− products, optionally wherein equal to or greater than 63% of the hydrogen content of the petroleum-based feedstock is redistributed to C4− products.

Para. 12. The process of Para. 10 or Para. 11, wherein equal to or less than 28% of the hydrogen content of the petroleum-based feedstock is redistributed to the aromatic gasoline, optionally wherein equal to or less than 25% of the hydrogen content of the petroleum-based feedstock is redistributed to the aromatic gasoline.

Para. 13. The process of any one of Paras. 1-12, wherein an atomic ratio of H to C in the aromatic gasoline is equal to or less than 1.46, optionally wherein the atomic ratio of H to C in the aromatic gasoline is less than 1.40.

Para. 14. The process of any one of Paras. 1-13, wherein the process does not comprise bed cracking.

Para. 15. The process of any one of Paras. 1-14, wherein the process does not comprise product recycle.

Para. 16. The process of any one of Paras. 1-15, wherein the petroleum-based feedstock comprises vacuum gas oil, atmospheric gas oil, coker gas oil, deasphalted oil, atmospheric resid, vacuum residue, or a mixture of any two or more thereof.

Para. 17. The process of any one of Paras. 1-16, wherein the petroleum-based feedstock comprises coal liquefied oil, tar sand oil, shale oil, or a mixture of any two or more thereof.

Para. 18. The process of any one of Paras. 1-17, wherein the petroleum-based feedstock further comprises a biorenewable feedstock and/or a plastics-derived feedstock, optionally wherein the biorenewable feedstock comprises a vegetable oil, an animal fat, a pyrolysis oil, or a mixture of any two or more thereof.

Para. 19. The process of any one of Paras 1-18, wherein contacting the petroleum-based feedstock with the catalyst converts at least a portion of the petroleum-based feedstock into products comprising a dry gas, a liquefied petroleum gas (LPG), a light cycle oil (LCO), a slurry, or a combination of any two or more thereof.

Para. 20. The process of Para. 19, wherein the dry gas and/or the LPG comprise the light olefins, and wherein the process further comprises one or more fractionation steps to fractionate the dry gas and/or LPG to yield ethylene, propylene, and/or butylene.

Para. 21. The process of any one of Paras. 1-17, wherein the process further comprises one or more fractionation steps to fractionate the aromatic gasoline to yield benzene, toluene, xylene, ethylbenzene, trimethylbenzene, methylethylbenzene, and/or propylbenzene.

Para. 22. A product comprising light olefins and gasoline produced by Para. 1.

Para. 23. The product of Para. 22, wherein C4− products are present in an amount equal to or greater than 60% of the hydrogen content of the petroleum-based feedstock.

Para. 24. The product of Para. 23, wherein C4− products are present in an amount equal to or greater than 63% of the hydrogen content of the petroleum-based feedstock.

Para. 25. The product of any one of Paras. 22-24, wherein aromatic gasoline is present in an amount equal to or less than 28% of the hydrogen content of the petroleum-based feedstock.

Para. 26. The product of Para. 25, wherein aromatic gasoline is present in an amount equal to or less than 25% of the hydrogen content of the petroleum-based feedstock.

Para. 27. The product of any one of Paras. 22-26, wherein the aromatic gasoline has an atomic ratio of H to C in of equal to or less than 1.46.

Para. 28. The product of Para. 27, wherein the atomic ratio of H to C of the aromatic gasoline is less than 1.40.

### EQUIVALENTS

The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

1. A catalytic cracking process for producing light olefins and aromatic gasoline, the process comprising:
contacting a petroleum-based feedstock with a catalyst in a single riser reactor at a temperature and a weight hourly space velocity (WHSV) to convert at least a portion of the petroleum-based feedstock into light olefins and aromatic gasoline;
wherein:
the catalyst comprises:
0 wt % to about 15 wt % of a Y-type zeolite; and
greater than 30 wt % of a pentasil zeolite;
where a weight ratio of the pentasil zeolite to the Y-type zeolite is greater than 3;
the temperature is from about 530° C. to about 600° C.;
the WHSV is from about 40 h⁻¹ to about 120 h⁻¹;
a weight ratio of catalyst to petroleum-based feedstock is from about 10:1 to about 30:1; and
the aromatic gasoline is obtained from C5+ to 221° C. cut point.

2. The process of claim 1, wherein the light olefins comprise ethylene, propylene, butylene, or a combination of any two or more thereof.

3. The process of claim 1, wherein the aromatic gasoline comprises benzene, toluene, xylene, ethylbenzene, trimethylbenzene, methylethylbenzene, propylbenzene, or a combination of any two or more thereof.

4. The process of claim 1, wherein the pentasil zeolite comprises ZSM-5.

5. The process of claim 1, wherein the pentasil zeolite is stabilized with P₂O₅, optionally wherein a weight ratio of P₂O₅ to the pentasil zeolite is from about 0.1:1 to about 0.3:1.

6. The process of claim 1, wherein the Y-type zeolite is stabilized with RE₂O₃, optionally wherein a weight ratio of RE₂O₃ to the Y-type zeolite is about 0.04:1 to about 0.15:1.

7. The process of claim 1, wherein the catalyst comprises 0 wt % to about 10 wt % of the Y-type zeolite and/or about 35 wt % to about 60 wt % of the pentasil zeolite.

8. (canceled)

9. The process of claim 1, wherein the WHSV is from about 40 h⁻¹ to about 70 h⁻¹.

10. The process of claim 1, wherein contacting the petroleum-based feedstock with the catalyst redistributes a hydrogen content of the petroleum-based feedstock by converting at least a portion of the petroleum-based feedstock to products, the products comprising the light olefins and the aromatic gasoline.

11. The process of claim 10, wherein equal to or greater than 60% of the hydrogen content of the petroleum-based feedstock is redistributed to C4 products and/or wherein equal to or less than 28% of the hydrogen content of the petroleum-based feedstock is redistributed to the aromatic gasoline.

12. (canceled)

13. The process of claim 1, wherein an atomic ratio of H to C in the aromatic gasoline is equal to or less than 1.46.

14. The process of claim 1, wherein the process does not comprise bed cracking and/or product recycle.

15. (canceled)

16. The process of claim 1, wherein the petroleum-based feedstock comprises vacuum gas oil, atmospheric gas oil, coker gas oil, deasphalted oil, atmospheric resid, vacuum residue, or a mixture of any two or more thereof and/or coal liquefied oil, tar sand oil, shale oil, or a mixture of any two or more thereof.

17. (canceled)

18. The process of claim 1, wherein the petroleum-based feedstock further comprises a biorenewable feedstock and/or a plastics-derived feedstock.

19. The process of claim 1, wherein contacting the petroleum-based feedstock with the catalyst converts at least a portion of the petroleum-based feedstock into products comprising a dry gas, a liquefied petroleum gas (LPG), a light cycle oil (LCO), a slurry, or a combination of any two or more thereof.

20. The process of claim 1, wherein contacting the petroleum-based feedstock with the catalyst converts at least a portion of the petroleum-based feedstock into products comprising a dry gas and/or a liquefied petroleum gas (LPG), wherein the dry gas and/or the LPG comprise the light olefins wherein the process further comprises one or more fractionation steps to fractionate the dry gas and/or the LPG to yield ethylene, propylene, and/or butylene and/or wherein the process further comprises one or more fractionation steps to fractionate the aromatic gasoline to yield benzene, toluene, xylene, ethylbenzene, trimethylbenzene, methylethylbenzene, and/or propylbenzene.

21. (canceled)

22. A product comprising light olefins and gasoline produced by claim 1.

23. The product of claim 22, wherein C4− products are present in an amount equal to or greater than 60% of the hydrogen content of the petroleum-based feedstock.

24. (canceled)

25. The product of claim 22, wherein aromatic gasoline is present in an amount equal to or less than 28% of the hydrogen content of the petroleum-based feedstock.

26. (canceled)

27. The product of claim 22, wherein the aromatic gasoline has an atomic ratio of H to C in of equal to or less than 1.46.

28. (canceled)
